(19) United States
(12) Patent Application Publication
(10) Pub. No.: US 2019/0228302 A1
(43) Pub. Date: Jul. 25, 2019

(54) LEARNING METHOD, LEARNING DEVICE, AND COMPUTER-READABLE RECORDING MEDIUM

(71) Applicant: FUJITSU LIMITED, Kawasaki-shi (JP)

(72) Inventor: Takahiro Saito, Asaka (JP)

(73) Assignee: FUJITSU LIMITED, Kawasaki-shi (JP)

(21) Appl. No.: 16/246,581

(22) Filed: Jan. 14, 2019

(30) Foreign Application Priority Data
Jan. 19, 2018 (JP) 2018-007640

(51) Int. Cl. G06N 3/08; G06N 20/00

(52) U.S. Cl. CPC G06N 3/08; G06N 20/00

(57) ABSTRACT

A non-transitory computer-readable recording medium stores therein a learning program that causes a computer to execute a process including: generating, from graph data subject to learning, extended graph data that has a value of each node included in the graph data, and a value corresponding to a distance between each node and another node included in the graph data; and obtaining input tensor data by performing tensor decomposition of the generated extended graph data, performing deep learning with a neural network by inputting the input tensor data into the neural network upon deep learning, and learning a method of the tensor decomposition.

### CROSS-REFERENCE TO RELATED APPLICATION

This application is based upon and claims the benefit of priority of the prior Japanese Patent Application No. 2018-007640, filed on Jan. 19, 2018, the entire contents of which are incorporated herein by reference.

### FIELD

The embodiment discussed herein is related to a computer-readable recording medium, a learning method, and a learning device.

### BACKGROUND

Graph-structure learning techniques enabling deep learning of data in a graph structure (hereinafter, one form of a device that performs this kind of graph structure learning is referred to as “Deep Tensor”) has been known. In learning by Deep Tensor, learning while automatically extracting partial structures that contribute to discrimination is enabled, besides learning of a neural network to perform deep learning.

Moreover, as for machine learning, it has been suggested to determine whether to subject an input vector to learning depending on a distance from the nearest node and the second nearest node, to stabilize learning results in a self-organizing neural network. Furthermore, it has been suggested to divide input data into clusters by using the Laplacian matrix. Moreover, it has been suggested to acquire geodesic distance relationship among processing data belonging to different classes and a distance between classes, and to make a geodesic distance between processing data belonging to the same class smaller than a distance from processing data belonging to another class based on interclass separation according to the distance between classes (Japanese Laid-open Patent Publication Nos. 2014-164396, 2016-004579, 2015-079381, and 2013-065336, Koji Maruhashi, “Deep Tensor: Eliciting New Insights from Graph Data that Express Relationships between People and Things”, Fujitsu Sci. Tech. J., Vol. 53, No. 5, pp. 26-31, September 2017).

When deep learning of data in a graph structure is performed, respective elements of nodes included in the graph and connection state of links (edges) are subject to learning. On the other hand, the discrimination rule in a discrimination model (learning model) in the deep learning is not limited only to presence or absence of a value of node or a link, but a rule relating to a state of chains of links can exist also. That is, a rule including a connection state of connecting through multiple nodes can exist also for connection between nodes in a partial graph structure that contributes to discrimination.

However, in Deep Tensor, because the discrimination rule is a partial graph structure, to include the rule relating to a state of chains of links, it is desired that all kinds of variations of partial graph structures expressing chains of discrimination rules are included in training data. However, when such a chain includes a node at a long distance or when a condition relating to a distance between chained nodes includes “within the specific number”, the variations of partial graph structures increase. Accordingly, it becomes difficult to train all of the variations, and the learning is to be incomplete. As a result, it is difficult to properly discriminate new data that includes a variation of a partial graph structure expressing the chain not included in the training data. That is, the discrimination accuracy in machine learning for a graph in which a chain state is different from that at learning decreases.

### SUMMARY

According to an aspect of the embodiment, a non-transitory computer-readable recording medium stores therein a learning program that causes a computer to execute a process including: generating, from graph data subject to learning, extended graph data that has a value of each node included in the graph data, and a value corresponding to a distance between each node and another node included in the graph data; and obtaining input tensor data by performing tensor decomposition of the generated extended graph data, performing deep learning with a neural network by inputting the input tensor data into the neural network upon deep learning, and learning a method of the tensor decomposition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating one example of a configuration of a learning device according to an embodiment;

FIG. 2 illustrates one example of relationship between a graph structure and a tensor;

FIG. 3 illustrates one example of extraction of a partial graph structure;

FIG. 4 illustrates one example of a weighted connection matrix in Deep Tensor;

FIG. 5 illustrates one example of a partial graph structure satisfying a condition;

FIG. 6 is a diagram for explaining a mathematical characteristic of a connection matrix;

FIG. 7 illustrates one example of training data;

FIG. 8 illustrates one example of calculation process;

FIG. 9 illustrates one example of extraction of a partial graph structure from extended graph data;

FIG. 10 illustrates one example of another learnable discrimination rule;

FIG. 11 illustrates one example of extraction of a partial graph structure corresponding to another discrimination rule from extended graph data;

FIG. 12 illustrates one example of another learnable discrimination rule;

FIG. 13 illustrates one example of another learnable discrimination rule;

FIG. 14 is a flowchart illustrating one example of learning processing of the embodiment;

FIG. 15 is a flow chart illustrating one example of discrimination processing of the embodiment; and

FIG. 16 illustrates one example of a computer that executes a learning program.

### DESCRIPTION OF EMBODIMENT(S)

Preferred embodiments will be explained with reference to accompanying drawings. The embodiments are not intended to limit the disclosed technique. Moreover, the following embodiments can be appropriately combined within a range not causing a contradiction.

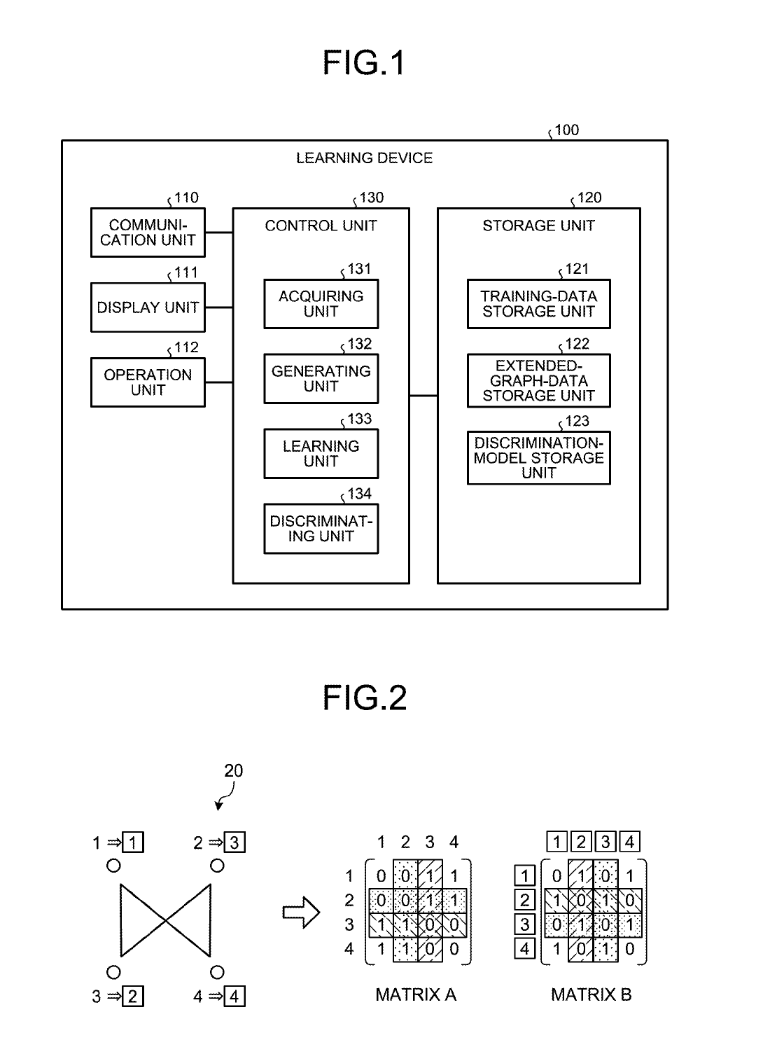

FIG. 1 is a block diagram illustrating one example of a configuration of a learning device according to the embodiment. A learning device 100 illustrated in FIG. 100 is an example of a learning device that generates a discrimination model by Deep Tensor performing deep learning of data in a graph structure, and that discriminates new data in a graph structure by using the discrimination model. The learning device 100 generates, from graph data subject to learning, extended graph data that has a value of each node included in the graph data, a value corresponding to a distance between each node and another node included in the graph data. The learning device 100 subjects the generated extended graph data to tensor factorization as input tensor data, inputs it to a neural network when performing deep learning to perform deep learning of a neural network, and learns a method of tensor factorization. A core tensor obtained as a result of the tensor factorization includes a partial structure that contributes to discrimination and, thus, the learning device 100 can improve the discrimination accuracy of machine learning for a graph in which a chain state is different from that at learning.

First, Deep Tensor is explained. Deep Tensor is deep learning in which a tensor (graph information) is input data, and in which a partial graph structure contributing to discrimination is automatically extracted besides learning of a neural network. This extraction processing is achieved by learning parameters in Tensor factorization of input tensor data besides learning of a neural network.

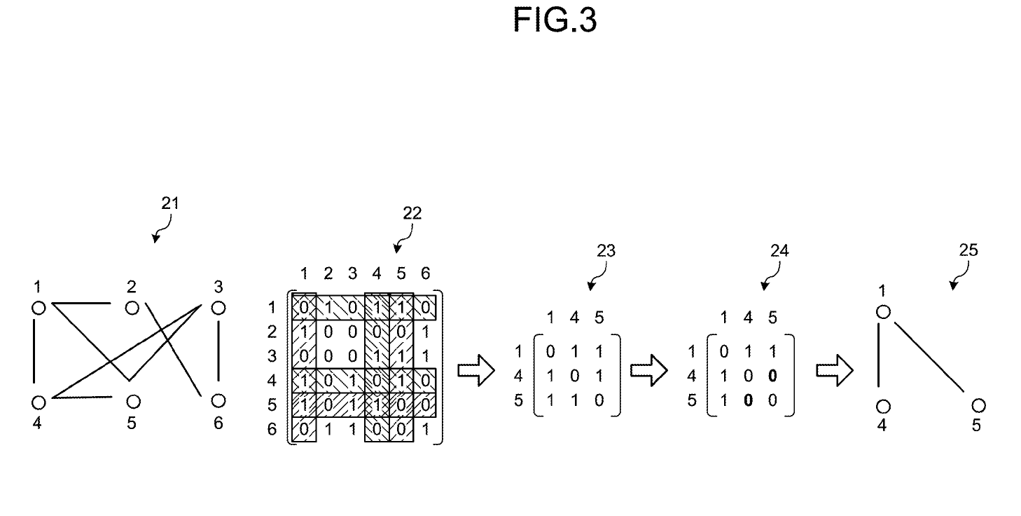

Next, a graph structure is explained, using FIG. 2 and FIG. 3. FIG. 2 illustrates one example of relationship between a graph structure and a tensor. A graph 20 illustrated in FIG. 2 has four nodes are connected by edges that indicate relationship (for example, “correlation coefficient is a predetermined value or larger”) between nodes. Note that there is no such relationship between nodes that are not connected by an edge. When the graph 20 is expressed by a tensor of the second order, that is, a matrix, a matrix expression based on a number on the left side of a node is, for example, expressed by “matrix A”, and a matrix expression based on a number on the right side (number in a box) of a node is expressed by “matrix B”. Respective components of these matrices are expressed by “1” when nodes are connected, and are expressed by “0” when nodes are not connected. In the following, such a matrix is also referred to as connection matrix. “Matrix B” can be generated by exchanging the second and the third rows and the second and the third columns of “matrix A” at the same time. In Deep Tensor, it is processed ignoring a difference in sequence by using such exchange processing. That is, “matrix A” and “matrix B” are handled as the same graph, ignoring the sequence in Deep Tensor. Note that tensors of the third order are processed similarly.

FIG. 3 illustrates one example of extraction of a partial graph structure. A graph 21 illustrated in FIG. 3 has six nodes that are connected by edges. The graph 21 can be expressed as in a matrix 22 when expressed in a matrix (tensor). By combining an operation exchange specific rows and columns, an operation to extract specific row and column, and an operation to replace a non-zero element in a connection matrix with zero for the matrix 22, a partial graph structure can be extracted. For example, when a matrix corresponding to “nodes 1, 4, 5” of the matrix 22, a matrix 23 is obtained. Next, by replacing a value between “nodes 4, 5” of the matrix 23 with zero, a matrix 24 is obtained. A partial graph structure corresponding to the matrix 24 is a graph 25.

Such extraction processing of a partial graph structure can be achieved by mathematical operation called tensor factorization. The tensor factorization is an operation in which an input tensor of the n-th order is approximated by a product of tensors of the n-th or lower order. For example, an input tensor of the n-th order is approximated by a product of one tensor of the n-th order (called core tensor) and n pieces of tensors of the lower order (when n>2, a tensor of the second order, that is, a matrix is used normally). This factorization is not unique, and any partial graph structure in a graph structure expressed by input data can be included in the core tensor.

Subsequently, handling of a weighted connection matrix in Deep Tensor is explained. A weighted connection matrix is a matrix in which when there is no connection between nodes, “0” is given, and when there is connection, its weight (>0) is given. An example of the weighted connection matrix is, for example, a matrix in which a communication frequency per unit time between a node i and a node j is an (i, j) component. On the other hand, in Deep Tensor, a weight of a connection matrix is handled as a label of an edge. Therefore, for example, an original characteristic of the value, such as magnitude relationship and calculation method, is not considered. In the example of the above computer network, when the (i, j) component is “2”, it is indicated that more communication is performed than a case in which this component is “1”. That is, the (i, j) component indicates the magnitude relationship of the value. On the other hand, in Deep Tensor, such a relationship is ignored, and a graph expressed by a matrix in which the (i, j) component is “2” and a graph expressed by a matrix in which the (i, j) component is “1” is handled as different graphs.

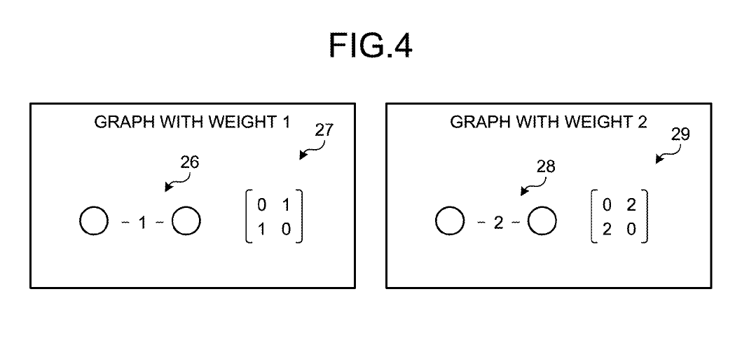

FIG. 4 illustrates one example of a weighted connection matrix in Deep Tensor. As illustrated in FIG. 4, for example, a graph 26 with a weight “1” and a matrix 27 are assumed to be extracted from training data as a partial graph structure that contribute to discrimination at learning. On the other hand, when a graph 28 with a weight “2” and a matrix 29 are assumed to be subject to discrimination, it is determined “not matching” at discrimination because the edge label differs from that of the graph 26 and the matrix 27. That is, in Deep Tensor, unless all kinds of variations of weighted connection matrices are included in the training data, the learning can be incomplete. In this case, it is desired that a discrimination rule in which information corresponding to a weight of a weighted connection matrix is generalized can be learned.

Variations of partial graph structure are explained with a specific example. First, it is assumed that a specific discrimination task is “to determine a dependence risk of a subject using a friend relationship graph of the subject as input data”. Examples of the dependence includes, for example, a gambling dependence, an alcohol dependence, and the like. As for these dependences, it has been found that “if his/her friend is a dependent patient, the person is likely to become dependent”, and it is supposed that a dependence risk can be determined based on whether a dependent patient is included in the friend relationship graph. In this case, an example a true discrimination rule is to be “if two dependent patients are included within distance 3, there is a high risk of dependence”. Note that the distance herein is expressed as a person directly connected to the subject of determination has distance “1” and a person connected thereto through one person has distance “2”.

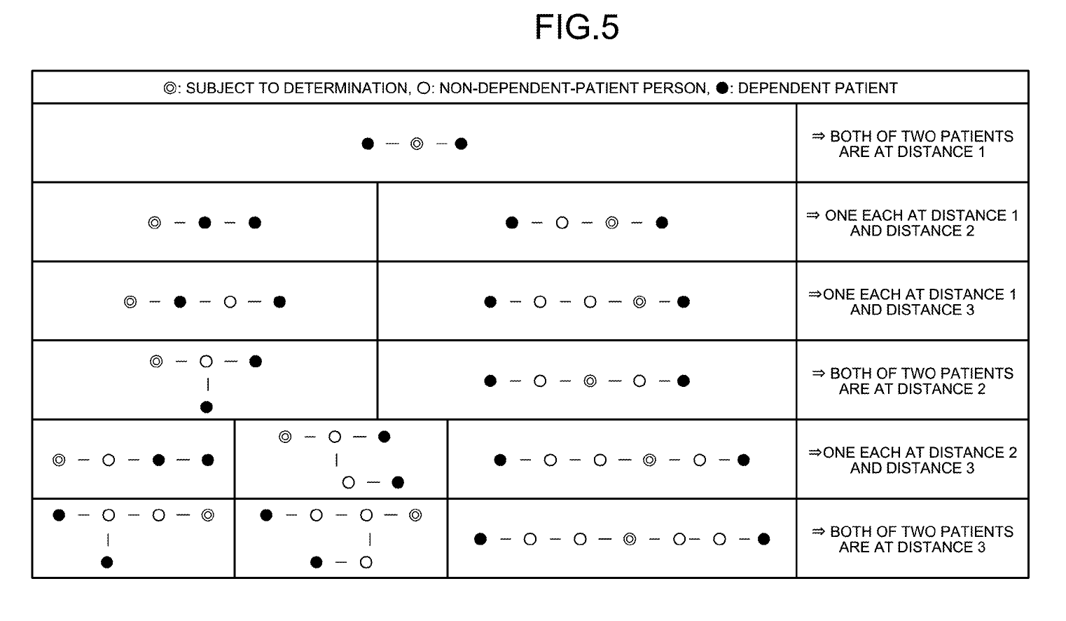

FIG. 5 illustrates one example of a partial graph structure satisfying a condition. As illustrated in FIG. 5, the partial graph structure that satisfies conditions of the true discrimination rule described above has 13 variations, and it is desired that training data cover all of the 13 variations to perform appropriate learning. In FIG. 5, ⊚ indicates a subject of determination, ◯ indicates a non-dependent-patient person, and ● indicates a dependent patient. The same marks can be used for a graph and a label of a connection matrix in the following explanation also. For example, “●-◯-⊚-●” indicates that one dependent patient is present in distances “1” and the “2”. Moreover, it indicates that the dependent patient in distance “2” is connected to the subject of determination through a non-dependent-patient friend, that is, through a person that is not a dependent patient.

Because the number of conditions of the true discrimination rule described above is 13, all kinds of variations can be prepared as training data. However, for conditions of more complicated discrimination rule, the number of variations increases and, therefore, it can be impossible to collect training data of all kinds of variations. On the other hand, in the present embodiment, by expressing the number of paths of distance n between nodes using a mathematical characteristic of a connection matrix, a generalized partial graph structure is extracted, and the extracted partial graph structure is learned.

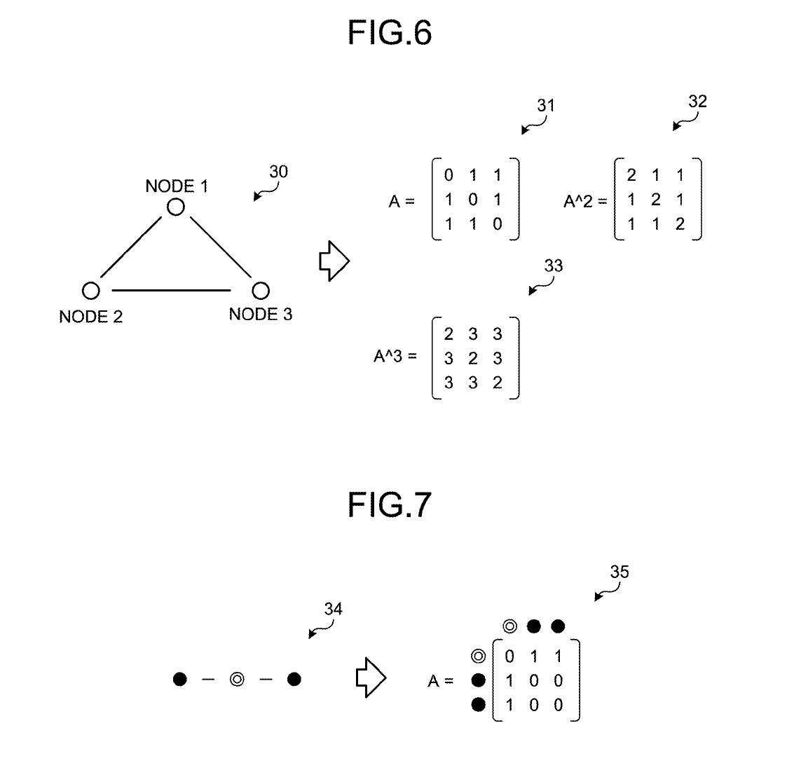

The mathematical characteristic of a connection matrix is explained, using FIG. 6. FIG. 6 is a diagram for explaining a mathematical characteristic of a connection matrix. As illustrated in FIG. 6, a graph 30 is a graph structure in which nodes “1 to 3” are connected to each other. When a connection matrix 31 of the graph 30 is A, the (i, j) component pf A\hat{ }n is the number of paths of distance n between the nodes i, j. Note that this value includes a round-trip path in the middle. That is, the (i, j) component at n-th power of the connection matrix indicates the number of paths having a length n between the node i and the node j. Adjacent nodes are nodes of distances “3, 5, 7, . . . ”.

For example, a connection matrix 32 expressing A\hat{ }2 indicates the number of paths of distance “2”, and a connection matrix 33 expressing A\hat{ }3 indicates the number of paths of distance “3”. As an example of a calculation result of the connection matrix 32, two patterns of nodes “1-2-1”, and nodes “1-3-1” are obtained when A\hat{ }2 (1, 1)=2. Similarly, for example, when A\hat{ }2 (1, 2)=1, one pattern of nodes “1-3-2” is obtained.

Moreover, as an example of a calculation result of the connection matrix 33, when A\hat{ }3 (1, 1)=2, two patterns of nodes “1-2-3-1”, and nodes “1-3-2-1” are obtained. Similarly, for example, when A\hat{ }3 (1, 2)=3, three patterns of nodes “1-2-1-3”, nodes “1-3-1-3”, and nodes “1-3-2-3” are obtained. When a path reached by distance k is present, by making a return at one edge thereamong, a path of distance k+2 is obtained. That is, A\hat{ }k(i, j)≤A\hat{ }(k+2)(i, j) applies.

Next, a configuration of the learning device 100 is explained. As illustrated in FIG. 1, the learning device 100 includes a communication unit 110, a display unit 111, an operation unit 112, a storage unit 120, and a control unit 130. The learning device 100 can include, in addition to the functional components illustrated in FIG. 1, various kinds of functional units included in a known computer, for example, a functional unit, such as various kinds of input devices and sound output devices.

The communication unit 110 is implemented, for example, by a network interface card (NIC), and the like. The communication unit 110 is a communication interface that is connected to other information processing apparatuses by wired or wireless connection through a network not illustrated, and that controls communication of information between the device and the other information processing apparatuses. The communication unit 110 receives training data for learning or new data subject to discrimination, for example, from a terminal of an administrator. Furthermore, the communication unit 110 transmits a learning result or a discrimination result to the terminal of the administrator.

The display unit 111 is a display device to display various kinds of information. The display unit 111 is implemented, for example by a liquid crystal display or the like as the display device. The display unit 111 displays various kinds of screens, such as a display screen input from the control unit 130.

The operation unit 112 is an input device that accepts various operations from a user of the learning device 100. The operation unit 112 is implemented, for example, by a keyboard, a mouse, and the like as an input device. The operation unit 112 outputs an operation input by a user to the control unit 130 as operation information. The operation unit 112 can be implemented by a touch panel or the like as the input device, and the display device of the display unit and the input device of the operation unit 112 can be integrated.

The storage unit 120 is implemented by a storage device of, for example, a semiconductor memory device, such as a random access memory (RAM) and a flash memory, a hard disk, an optical disk, and the like. The storage unit 120 includes a training-data storage unit 121, an extended-graph-data storage unit 122, and a discrimination-model storage unit 123. Moreover, the storage unit 120 stores information used in processing by the control unit 130.

The training-data storage unit 121 stores, for example, training data subject to learning input through the communication unit 110. The training-data storage unit 121 stores, for example, graph data subject to learning corresponding to a graph that expresses a part of the determination rule relating to a dependent patient as training data.

The extended-graph-data storage unit 122 stores a matrix in which a distance matrix based on a matrix obtained by exponentiating a connection matrix corresponding to a graph of training data according to a distance number for a longest distance between respective nodes included in the training data is a diagonal component, as extended graph data.

The discrimination-model storage unit 123 stores a discrimination model in which the expanded graph data is subjected to deep learning. The discrimination model is also called learning model, and stores, for example, various kinds of parameters (weighting factor), a method of tensor factorization, and the like of a neural network.

The control unit 130 is implemented, for example by a central processing unit (CPU), a micro-processing unit (MPU), or the like executing a program stored in an internal storage device, using a RAM as a work area. Moreover, the control unit 130 can be implemented also by an integrated circuit, such as an application specific integrated circuit (ASIC) and a field programmable gate array (FPGA). The control unit 130 includes an acquiring unit 131, a generating unit 132, a learning unit 133, and a discriminating unit 134, and implements or performs functions and actions of information processing explained below. An internal configuration of the control unit 130 is not limited to the configuration illustrated in FIG. 1, but can take another configuration as long as it is a configuration to perform the information processing described later.

The acquiring unit 131 receives and acquires training data for learning from a terminal of an administrator and the like through the communication unit 110. The acquiring unit 131 converts, when the training data is a graph, into a corresponding connection matrix. The acquiring unit 131 stores the acquired matrix (connection matrix) or a connection matrix obtained by conversion in the training-data storage unit 121 as training data. Having stored the training data in the training-data storage unit 121, the acquiring unit 131 outputs a generation instruction to the generating unit 132.

The training data is explained, using FIG. 7. FIG. 7 illustrates one example of training data. Because a graph 34 in FIG. 7 is “●-⊚-●”, two dependent patients are both in distance “1” from the subject to determination. The graph 34 is expressed in a matrix as in a connection matrix 35. The acquiring unit 131 stores, for example, the connection matrix 35 in the training-data storage unit 121 as training data.

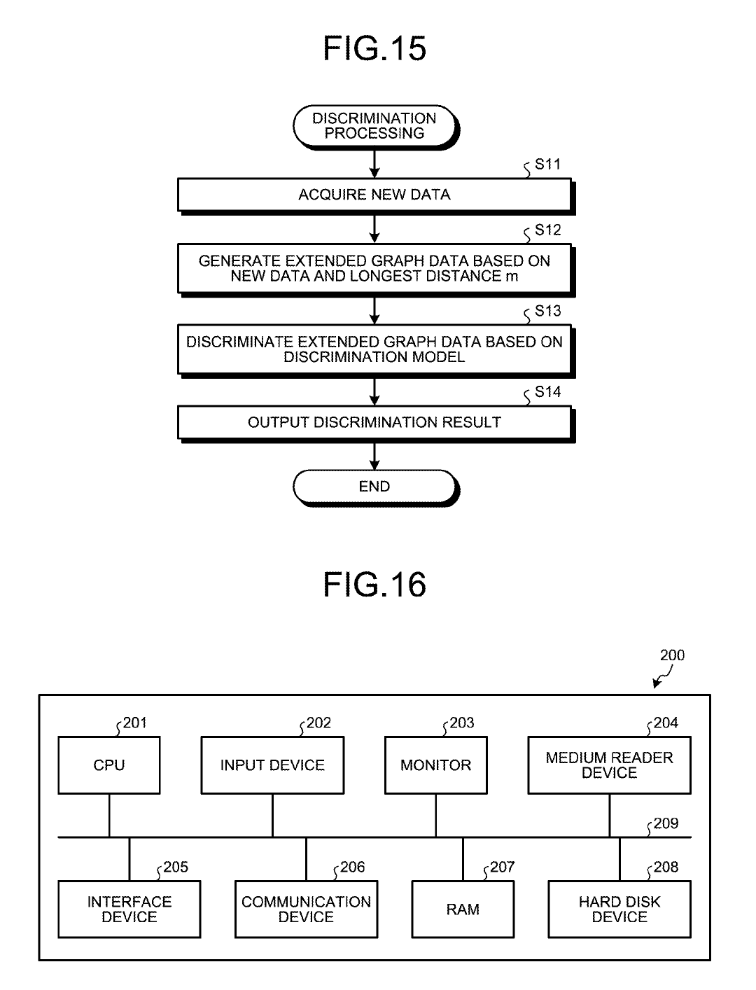

Returning back to FIG. 1, the generating unit 132 refers to the training-data storage unit 121 when the generation instruction is input from the acquiring unit 131, and generates extended graph data based on the training data. The generating unit 132 first calculates the longest distance in respective training data. The generating unit 132 determines a largest value among the calculated longest distance in the respective training data as longest distance m. For example, in the partial graph structure of 13 patterns (13 variations) illustrated in FIG. 15, longest distance m=3. Longest distance m can be determined to an appropriate value based on knowledge in a field to be determined. For example, if it is found that there is no influence when it is distant by distance “10” or more” in one field, it can be determined that longest distance m=9.

Next, the generating unit 132 calculates S_k that expresses the number of paths within distance k by using k=1, 2, . . . , m based on longest distance m. That is, the generating unit 132 calculates S_k=A+A\hat{ }2+ . . . A\hat{ }k. A expresses a connection matrix. Subsequently, the generating unit 132 calculates an n×n matrix B_k that is defined by following rules R1, R2, based on S_k. In the following explanation, B_k is also expressed as distance matrix. Moreover, S_k can also be S_k=A\hat{ }(k−1)+A\hat{ }k when k>1 by using the mathematical characteristic of a connection matrix.

As for a component (i, j) of S_k, the rule R1 is B_k(i, j)=1 where i=j. The rule R2 is B_k(i, j)=k+1 when S_k(i, j)>0, and B_k(i, j)=0 when S_k(i, j)=0 where i≠j. That is, the distance matrix B_k excludes an unnecessary round trip from S_k.

The distance matrix B_k thus calculated is to be a weighted connection matrix in which a set of nodes for which a path within distance k is present are connected by a weight k+1 in the connection matrix A. That is, the generating unit 132 calculates the weighted connection matrix B_k in which non-zero elements of A+A\hat{ }2+ . . . A\hat{ }k are k+1, and a diagonal component is 1.

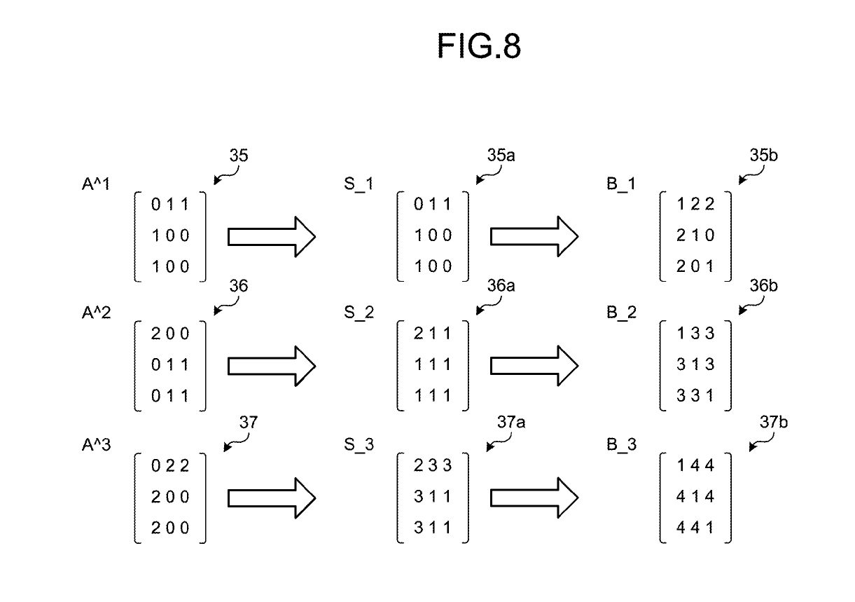

A calculation process of the distance matrix B_k is explained, using FIG. 8. FIG. 8 illustrates one example of the calculation process. FIG. 8 illustrates a calculation process of S_k and B_k (k=3) using the connection matrix 35 illustrated in FIG. 7 as A. First, A\hat{ }1 is to be the connection matrix 35, and S_1 is to be a connection matrix 35a that is same as the connection matrix 35 from S_1=A. Moreover, B_1 is to be a distance matrix 35b based on the rules R1, R2 described above.

A\hat{ }2 is to be a connection matrix 36, and S_2 is to be a connection matrix 36a from S_2=A+A\hat{ }2. Furthermore, B_2 is to be a distance matrix 36b based on the rules R1, R2 described above. A\hat{ }3 is to be a connection matrix 37, and S_3 is to be a connection matrix 37a from S_3=A+A\hat{ }2+A\hat{ }3. Moreover, B_3 is to be a distance matrix 37b based on the rules R1, R2 described above.

Next, the generating unit 132 generates a matrix expressed by following Equation (1) based on the generated distance matrix B_k. E is an n×n unit matrix. In the example in FIG. 8, the generating unit 132 generates a matrix Y in which B_1, B_2, B_3 are diagonal components. That is, the generating unit 132 generates the matrix Y in which B_1 to B_m are synthesized together with inter-node relationship information.

$$Y = ( \begin{matrix}B\_ 1 & E & E & ⋯ & E \\ E & B\_ 2 & E & ⋯ & E \\ & & ⋯ & & \\ E & E & & ⋯ & B\_m\end{matrix} ) \qquad ( 1 )$$

The generating unit 132 stores the matrix Y expressed by Equation (1) in the extended-graph-data storage unit 122 as extended graph data. Having stored the extended graph data in the extended-graph-data storage unit 122, the generating unit 132 outputs a learning instruction to the learning unit 133.

In other words, the generating unit 132 generates extended graph data that has a value of each node included in graph data, and a value corresponding to a distance between each node and another node included in the graph data from graph data subject to learning. That is, the generating unit 132 generates a connection matrix (A) that expresses connection of each node and another node, and generates a matrix (Y) in which a distance matrix (B_k) based on the generated connection matrix is a diagonal component. That is, the generating unit 132 calculates a longest distance (m) between respective nodes included in the graph data, and generates respective distance matrices (B_k) based on a matrix (S_k) that is obtained by exponentiating the connection matrix (A) according to the distance number to the calculated longest distance. The generating unit 132 generates a matrix (Y) in which the respective generated distance matrices are diagonal components as extended graph data.

The learning unit 133 refers to the extended-graph-data storage unit 122 when the learning instruction is input from the generating unit 132, and learns the extended graph data to generate or update a discrimination model. That is, the learning unit 133 subjects the extended graph data to tensor factorization, and generates a core tensor (partial graph structure). The learning unit 133 inputs the generated core tensor in a neural network to obtain an output. The learning unit 133 learns such that an error of an output value decreases, and learns parameters of the tensor factorization such that the discrimination accuracy increases. The tensor factorization has flexibility, and parameters of the tensor factorization include a combination of a factorization model, a constraint, and an optimization algorithm, and the like. Examples of the constraint include an orthogonal constraint, a sparse constraint, a smooth constraint, a non-negative constraint, and the like. Examples of the optimization algorithm include alternating least square (ALS), higher order singular value decomposition (HOSVD), higher order orthogonal interaction of tensors (HOOI), and the like. In Deep Tensor, the tensor factorization is performed under a constraint that “discrimination accuracy increases”.

Thereafter, when the learning has been performed a predetermined number of times, or when an error has become smaller than a predetermine value, the learning unit 133 ends learning, and stores various kinds of parameters, a method of tensor factorization, and the like in the discrimination-model storage unit 123 as a discrimination model. As for the neural network, various kinds of neural networks, such as a recurrent neural network (RNN), can be used. Moreover, as the learning method, various kinds of methods, such as backpropagation, can be used.

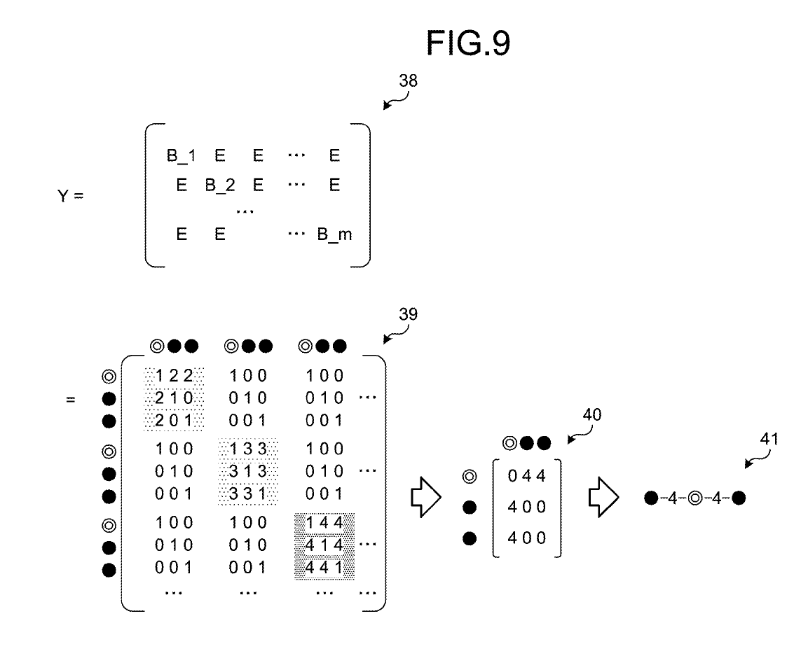

Extraction of a partial graph structure is explained, using FIG. 9. FIG. 9 illustrates one example of extraction of a partial graph structure from extended graph data. As illustrated in FIG. 9, a matrix 39 is a matrix obtained by expanding a matrix 38 of extended graph data (Y), and has, for example, the distance matrices 35b, 36b, 37b corresponding to B_1, B_2, B_3 in FIG. 8 as diagonal components. The learning unit 133 extracts a matrix 40 in a partial graph structure by combining the operation to exchange specific rows and columns, the operation to extract specific rows and columns, and the operation to replace a non-zero element with zero in a connection matrix. In the example of FIG. 9, the learning unit 133 generates the matrix 40 by the operation of replacing a part of values of the distance matrix 37b corresponding to B_3 with zero. The partial graph structure corresponding to the matrix 40 is a graph 41. In deep Tensor, a numerical meaning of each value in an input component, for example, magnitude relationship of a value, is not considered, and is handled as a label of an edge. As for the meaning of labels, a label “1” signifies the same person, and a label “n (n>1)” indicates that it is connectable when smaller than distance n.

The graph 41 is a weighted graph in which a label indicating that it is smaller than distance “4” is assigned to an edge connecting a subject to determination and two dependent patients, respectively. That is, the graph 41 indicates that the two dependent patients are both present within a distance smaller than distance “4” from the subject to determination. That is, the graph 41 is a partial graph structure expressing that “if two dependent patients are included within distance 3, there is a high risk of dependence” given as an example of the true discrimination rule described above. Therefore, while it is desired that all of 13 variations of partial graph structures be extracted to perform learning in the example of FIG. 5, one of the variations of partial graph structures of the graph 41 is sufficient to be extracted to perform learning in the learning device 100. Accordingly, the learning device 100 can learn a generalized discrimination rule even when an amount of training data is small.

In other words, the learning unit 133 subjects the generated extended graph data to tensor factorization as input tensor data, inputs it, when performing deep learning, to a neural network to perform deep learning of the neural network, and learns a method of tensor factorization.

Returning back to explanation of FIG. 1, the discriminating unit 134 acquires new data after learning of a discrimination model, and outputs a discrimination result obtained by discrimination using the discrimination model. The discriminating unit 134 receives and acquires new data to be subject to discrimination, for example, from a terminal of an administrator through the communication unit 110. The discriminating unit 134 generates extended graph data based on the acquired new data similarly to the generating unit 132 at learning.

The discriminating unit 134 refers to the discrimination-model storage unit 123, and discriminates the generated extended graph data by using the discrimination model. That is, the discriminating unit 134 establishes a neural network in which various kinds of parameters of the discrimination model are set, and sets a method of tensor factorization. The discriminating unit 134 subjects the generated extended graph data to tensor factorization, and input it into a neural network to acquire a discrimination result. The discriminating unit 134 outputs the acquired discrimination result to the display unit 111 to have it displayed, and outputs it to the storage unit 120 to have it stored therein.

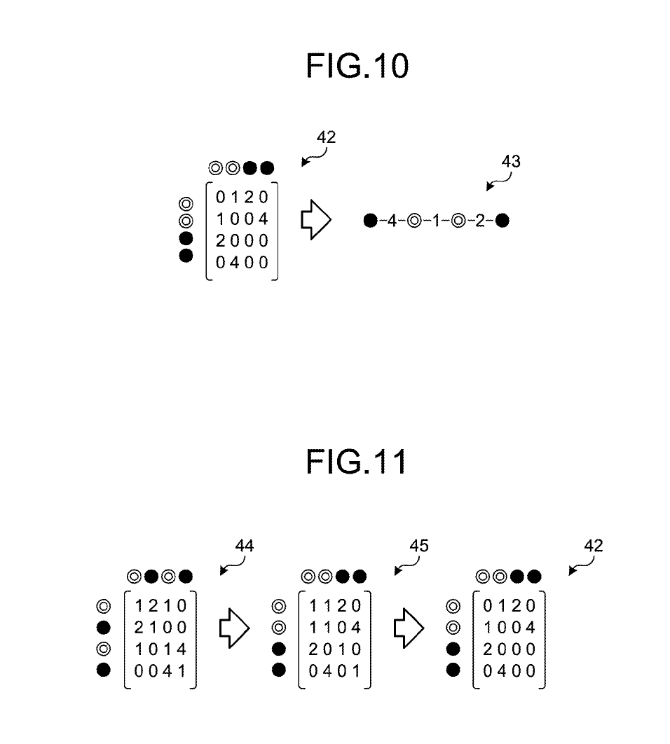

A case of another discrimination rule is explained, using FIG. 10 to FIG. 13. FIG. 10 illustrates one example of another learnable discrimination rule. In the example of FIG. 10, it is assumed that “two dependent patients are present within distance “3”, and one of them is at distance “1”” as a discrimination rule. A matrix expressing a partial graph structure corresponding to this discrimination rule is a matrix 42. A graph 43 is a graph when the matrix 42 is expressed by a weighted graph. The graph 34 of training data illustrated in FIG. 7 matches with this discrimination rule. The matrix 39 of FIG. 9 that is a matrix generated based on the graph 34 includes the matrix 42. That is, the matrix 39 includes the partial graph structure expressed by the graph 43. Therefore, the learning device 100 can learn the discrimination rule.

A procedure of extracting the matrix 42 from the matrix 39 is explained, using FIG. 11. FIG. 11 illustrates one example of extraction of a partial graph structure corresponding to another discrimination rule from extended graph data. As illustrated in FIG. 11, the learning device 100 extracts rows and columns 1, 2, 7, 9 from the matrix 39 to generate a matrix 44. The learning device 100 exchanges rows and columns 2, 3 of the matrix 44 to generate a matrix 45. The learning device 100 replaces diagonal components of the matrix 45 with zero to generate the matrix 42. Thus, the matrix 42 can be obtained from the matrix 39 by using the operations allowed for extraction of a partial graph structure and, therefore, it can be said that the extended graph data expressed by the matrix 39 includes the graph 43 that is a partial graph structure corresponding to the matrix 42.

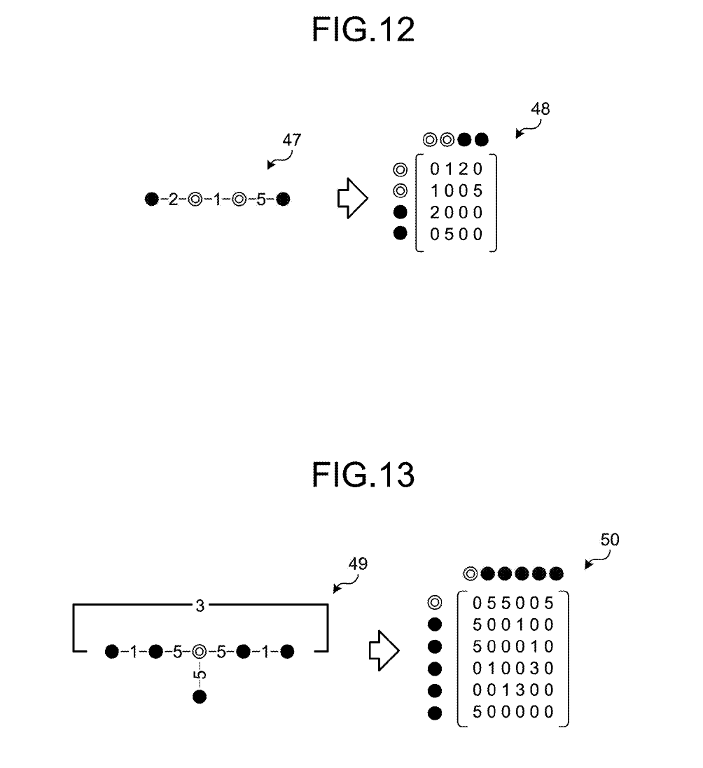

Another example of learnable generalized discrimination rule is explained, using FIG. 12 and FIG. 13. FIG. 12 illustrates one example of another learnable discrimination rule. In the example of FIG. 12, it is assumed that “two dependent patients are present within distance “4”, and one of them is at distance “1”” as a discrimination rule. Training data that matches with this discrimination rule is to include a partial graph data expressed by a graph 47. A matrix expression corresponding to the graph 47 is a matrix 48. That is, the learning device 100 can learn the discrimination rule described above by learning the training data that includes the matrix 48.

FIG. 13 illustrates one example of another learnable discrimination rule. In the example of FIG. 13, it is assumed that “three dependent patients are present within distance “4”, and at least two of them are within distance “2”” as a discrimination rule. Training data that matches with this discrimination rule is to include a partial graph structure expressed by a graph 49. A matrix expression corresponding to the graph 49 is a matrix 50. That is, the learning device 100 can learn the discrimination rule described above by learning the training data that includes the matrix 50. The learning device 100 can learn a discrimination rule easily even when it is a complicated discrimination rule as illustrated in FIG. 12 and FIG. 13 because all training data that match with the discrimination rule include the same partial graph structure.

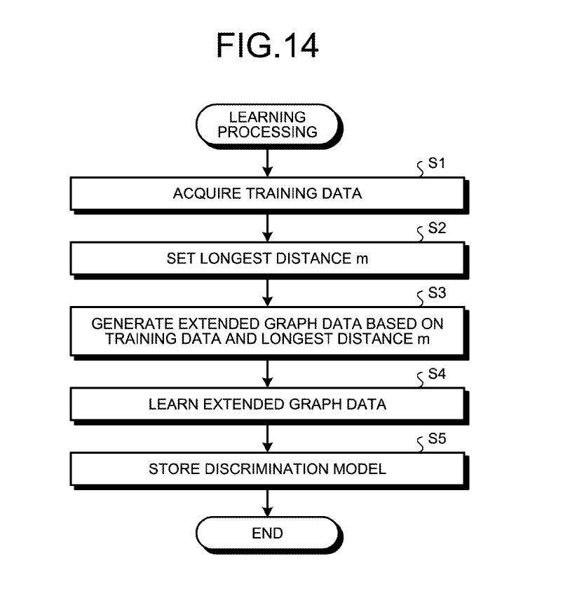

Next, actions of the learning device 100 of the embodiment are explained. First, the learning processing of learning a discrimination is explained. FIG. 14 is a flowchart illustrating one example of the learning processing of the embodiment.

The acquiring unit 131 receives and acquires training data for learning, for example, from a terminal of an administrator or the like (step S1). The acquiring unit 131 stores the acquired training data in the training-data storage unit 121. Having stored the training data in the training-data storage unit 121, the acquiring unit 131 outputs a generation instruction to the generating unit 132.

The generating unit 132 calculates a longest distance in each training data when the generation instruction is input from the acquiring unit 131. The generating unit 132 sets the largest value among the calculated longest distances of the respective training data to the longest distance m (step S2). The generating unit 132 refers to the training-data storage unit 121, and generates extended graph data based on the training data and the longest distance m (step S3). The generating unit 132 stores the generated extended graph data in the extended-graph-data storage unit 122. Having stored the extended graph data in the extended-graph-data storage unit 122, the generating unit 132 outputs a learning instruction to the learning unit 133.

The learning unit 133 refers to the extended-graph-data storage unit 122 when the learning instruction is input from the generating unit 132, and learns the extended graph data (step S4). The learning unit 133 ends learning when the learning has been performed predetermined number of times, or when an error has become smaller than a predetermined value, and stores various kinds of parameters, a method of tensor factorization, and the like in the discrimination-model storage unit 123 as a discrimination model (step S5). Thus, the learning device 100 can improve the discrimination accuracy of machine learning for a graph in which a chain state is different from that at learning. Moreover, the learning device 100 can learn a discrimination rule even with a small amount of training data because extended graph data includes a partial graph structure in which connection between nodes at long distance are to be adjacent nodes, and variations of partial graph structure including the nodes at long distance are significantly suppressed.

Subsequently, the discrimination processing of discriminating new data is explained. FIG. 15 is a flow chart illustrating one example of the discrimination processing of the embodiment.

The discriminating unit 134 receives and acquires new data subject to discrimination, for example, from a terminal of an administrator or the like (step S11). The discriminating unit 134 generates extended graph data based on the acquired new data and the longest distance m (step S12). The discriminating unit 134 refers to the discrimination-model storage unit 123, and discriminates the generated extended graph data by using a discrimination model (step S13). The discriminating unit 134 outputs a discrimination result of the discrimination model to, for example, the display unit 111 to have it displayed (step S14). Thus, the learning device 100 can discriminate, even when the data is a graph in which a chain state is different from that at learning, data in a graph structure having a common partial graph structure common as the training data. That is, the learning device 100 can improve the discrimination accuracy of machine learning for a graph in which a chain state is different from that at learning.

As described, the learning device 100 generates, from graph data subject to learning, extended graph data extended graph data that has a value of each node included in the graph data, a value corresponding to a distance between each node and another node included in the graph data. Furthermore, the learning device 100 subjects the generated extended graph data to tensor factorization as input tensor data, inputs it to a neural network when performing deep learning to perform deep learning of the neural network, and learns a method of tensor factorization. As a result, the learning device 100 can improve the discrimination accuracy of machine learning for a graph in which a chain state is different from that at learning.

The learning device 100 generates a connection matrix expressing connection between each node and another node, and generates a matrix in which a distance matrix based on the generated connection matrix is orthogonal components as extended graph data. As a result, the learning device 100 can perform learning with a small amount of training data even when a node at long distance is included or when a condition indicating “within the specific number” is included.

Moreover, the learning device 100 calculates a longest distance between nodes included graph data, and generates respective distance matrices based on a matrix that is obtained by exponentiating a connection matrix according to the distance number to the calculated longest distance. Furthermore, the learning device 100 generates a matrix in which the respective generated distance matrices are diagonal components as extended graph data. As a result, the learning device 100 can perform learning with a small amount of training data even when a node at long distance is included or when a condition indicating “within the specific number” is included.

In the above embodiment, an RNN has been used as an example of a neural network, but it is not limited thereto. Various kinds of neural networks, for example, a convolutional neural network (CNN), can be used. Moreover, for the learning method also, various publicly-known methods can be applied other than the backpropagation. Furthermore, a neural network has a multi-level structure that is constituted of, for example, an input layer, a middle layer (hidden layer), and an output layer, and each layer has a structure in which nodes are connected by edges. Each layer has a function called “activation function”, and an edge has a “weight”, A value of each node is calculated from a value of node of a previous layer, a value of weight of a connecting edge, and an activation function of the layer. As for the calculation method, various publicly-known methods can be applied. Furthermore, as for the machine learning, various kinds of methods, such as a support vector machine (SVM), can be used other than the neural network.

Furthermore, the respective components of the respective illustrated units are not necessarily requested to be configured physically as illustrated. That is, specific forms of distribution and integration of the respective units are not limited to the ones illustrated, and all or a part thereof can be configured to be distributed or integrated functionally or physically in arbitrary units according to various kinds of loads, usage conditions, and the like. For example, the acquiring unit 131 and the generating unit 132 can be integrated. Moreover, the respective illustrated processing is not limited to be performed in the sequence described above, but can be performed at the same time, or can be performed, switching the sequences within a range not causing a contradiction in the processing.

Furthermore, as for the respective processing functions performed by the respective devices, all or an arbitrary part thereof can be implemented on a CPU (or a microcomputer, such as an MPU and a micro controller unit (MCU)). Moreover, it is needless to say that all or a part of the respective processing functions can be implemented on a computer program that is analyzed and executed by a CPU (or a microcomputer, such as an MPU and MCU), or on hardware by wired logic.

The various kinds of processing explained in the above embodiment can be implemented by executing a program that has been prepared in advance by a computer. Therefore, in the following, one example of a computer that executes a program implementing functions similar to those of the above embodiment is explained. FIG. 16 illustrates one example of a computer that executes a learning program.

As illustrated in FIG. 16, a computer 200 includes a CPU 201 that executes various kinds of arithmetic processing, an input device 202 that accepts data input, and a monitor 203. Furthermore, the computer 200 includes a medium reader device 204 that reads a program and the like from a recording medium, an interface device 205 to connect with various kinds of devices, and a communication unit 206 to connect with other information processing apparatuses and the like by wired or wireless connection. Moreover, the computer 200 includes a RAM 207 that stores various kinds of information temporarily, and a hard disk device 208. The respective devices 201 to 208 are connected to each other through a bus 209.

The hard disk device 208 stores a learning program that has similar functions as the respective processing units of the acquiring unit 131, the generating unit 132, the learning unit 133, and the discriminating unit 134. Furthermore, the hard disk device 208 stores various kinds of data to implement the training-data storage unit 121, the extended-graph-data storage unit 122, the discrimination-model storage unit 123, and the learning program. The input device 202 accepts input of various kinds of information, such as operation information from an administrator of the computer 200, for example. The monitor 203 displays various kinds of screens, such as a display screen for, for example, an administrator of the computer 200. To the interface device 205, for example, a printer device and the like are connected. The communication device 206 has a function similar to that of the communication unit 110 illustrated in FIG. 1 and is connected to a network not illustrated, and communicates various kinds of information with other information processing apparatuses.

The CPU 201 performs various kinds of processing by reading respective programs stored in the hard disk device 208, developing them to execute on the RAM 207. These programs can cause the computer 200 to function as the acquiring unit 131, the generating unit 132, the learning unit 133, and the discriminating unit 134 illustrated in FIG. 1.

The learning program described above is not necessarily requested to be stored in the hard disk device 208. For example, the computer 200 can read a program stored in a storage medium that can be read by the computer 200 to execute it. The storage medium that can be read by the computer 200 corresponds to, for example, a portable recording medium, such as a compact disc read-only memory (CD-ROM), a digital versatile disc (DVD), and a universal serial bus (USB) memory, a semiconductor memory, such as a flash memory, a hard disk drive, and the like. Alternatively, the learning program can be stored in a device connected to a public line, the Internet, a local area network (LAN), and the like, and can be executed by the computer 200 by reading the learning program from these.

The discrimination accuracy in machine learning for a graph in which a chain state is different from that at learning can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a learning program that causes a computer to execute a process comprising:
generating, from graph data subject to learning, extended graph data that has a value of each node included in the graph data, and a value corresponding to a distance between each node and another node included in the graph data; and
obtaining input tensor data by performing tensor decomposition of the generated extended graph data, performing deep learning with a neural network by inputting the input tensor data into the neural network upon deep learning, and learning a method of the tensor decomposition.

2. The non-transitory computer-readable recording medium according to claim 1, wherein the generating includes generating a connection matrix that expresses connection between each node and another node, and generating a matrix in which a distance matrix based on the generated connection matrix is a diagonal component, as the extended graph data.

3. The non-transitory computer-readable recording medium according to claim 2, wherein the generating includes calculating a longest distance between respective nodes included in the graph data, generating respective distance matrices based on a matrix obtained by exponentiating the connection matrix according to a distance number to the calculated longest distance, and generating a matrix in which the respective generated distance matrices are diagonal components, as the extended graph data.

4. A learning method comprising:
generating, from graph data subject to learning, extended graph data that has a value of each node included in the graph data, and a value corresponding to a distance between each node and another node included in the graph data; and
learning a method of tensor factorization, while subjecting the generated extended graph data, as input tensor data, to the tensor factorization to input to a neural network at deep learning to perform deep learning of the neural network, by a processor.

5. A learning device comprising:
a processor configured to:
generate, from graph data subject to learning, extended graph data that has a value of each node included in the graph data, and a value corresponding to a distance between each node and another node included in the graph data; and
learn a method of tensor factorization, while subjecting the generated extended graph data, as input tensor data, to the tensor factorization to input to a neural network at deep learning to perform deep learning of the neural network.
